(19) United States
(12) Patent Application Publication
(10) Pub. No.: US 2006/0072819 A1
(43) Pub. Date: Apr. 6, 2006

(54) Image forming apparatus and method

(75) Inventors: Naofumi Yamamoto, Kanagawa-ken (JP); Takahiro Fuchigami, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/958,351

(22) Filed: Oct. 6, 2004

(51) Int. Cl. G06K 9/34

(52) U.S. Cl. 382/173

(57) ABSTRACT

A method and apparatus of copying a document includes scanning a document and obtaining an image signal from the scanned document. Micro segmentation processing is performed on the image signal, and first data indicative of a type of pixel is output for at least one pixel. Macro segmentation processing is performed on the image signal, and second data indicative of a type of the pixel and a validity flag that indicates whether the second data is valid are output for the at least one pixel. A pixel type determination is made based on the validity flag and at least one of the first data and the second data.

### FIELD OF THE INVENTION

The present invention relates generally to a multi-function peripheral (MFP) and a method for copying a document, more particularly, to an apparatus and method of selectively using both micro segmentation and macro segmentation for determining appropriate parameters for copying different areas of a document image.

### BACKGROUND OF THE INVENTION

In a conventional copier or MFP or image forming apparatus (hereinafter, for ease, collectively referred to as “copier”), an original document is scanned and then the scanned data is processed in order to determine the appropriate filtering and other processing parameters to perform on the image data prior to sending that data to a printing unit.

In order to determine the appropriate types of processing to perform on the scanned data, it is necessary to determine the type of area (or region) on various portions of the original document. For example, scanned data that corresponds to text data of a document should be filtered by an image processing unit in a different manner than scanned data that corresponds to graphics data of that same document.

U.S. Pat. No. 6,043,823, which is incorporated in its entirety herein by reference, describes a first conventional method in which different portions of a document are selectively extracted and processed, in order to determine optimum processing parameters for the different portions. A division section divides a document image into a plurality of regions, and a recognition section recognizes an image type for each region. An edit section edits region data while displaying the recognition result. A shaping section shapes the document image by using the edited region data.

U.S. Pat. No. 6,424,742, which is incorporated in its entirety herein by reference, describes a second conventional method in which a document image is separated into plural types of fields in response to a first image signal obtained at a rough density of the supplied original image, a characteristic value calculating section for calculating a characteristic value of the original image in response to a second image signal obtained at a higher density than the first image signal, and a discrimination section for discriminating an image field of the original image in accordance with the characteristic value to correspond to the type of the field.

As described in detail in U.S. Pat. No. 6,424,742, a document image is first “roughly scanned” and that data is used to determine characteristics of the document based on macro segmentation-type processing. Then, the document image is scanned more precisely, and that data is used to determine characteristics of the document based on micro segmentation-type processing.

While the general use of both micro segmentation and macro segmentation provides for fairly precise printing of a document having different types of images (e.g., photo image on a top left portion of the document, graphics image on the top right portion of the document, and text on the bottom half of the document), the inventors of this application have determined that such a system and method can be improved in order to account for cases where some of the segmentation data obtained may not be accurate.

Accordingly, there exists a desire to provide a copier that copies documents using both micro segmentation processing and macro segmentation processing in a more effective manner than has been utilized in conventional copiers, to obtain better segmentation processing.

### SUMMARY OF THE INVENTION

According to an aspect of the invention, a method of copying a document includes scanning a document and obtaining an image signal from the scanned document. The method also includes performing micro segmentation processing on the image signal, and outputting, for at least one pixel, first data indicative of a type of the pixel. The method further includes performing macro segmentation processing on the image signal, and outputting, for the at least one pixel, second data indicative of a type of the pixel and a validity flag that indicates whether the second data is valid. The method also includes determining a pixel type based on the validity flag and at least one of the first data and the second data.

According to another aspect of the invention, an image forming apparatus includes a scanning unit configured to scan a document and to obtain an image signal from the scanned document. The image forming apparatus also includes a micro segmentation processing unit configured to perform micro segmentation processing on the image signal, and to output, for at least one pixel, first data indicative of a type of the pixel. The image forming apparatus further includes a macro segmentation processing unit configured to perform macro segmentation processing on the image signal, and to output, for the at least one pixel, second data indicative of a type of the pixel and a validity flag that indicates whether the second data is valid. The image forming apparatus also includes a final decision unit configured to determine a pixel type based on the validity flag and at least one of the first data and the second data.

Further features, aspects and advantages of the present invention will become apparent from the detailed description of preferred embodiments that follows, when considered together with the accompanying figures.

### BRIEF DESCRIPTION OF THE DRAWINGS

FIG. 1 is a block diagram showing print components used by a conventional copier;

FIG. 2 is a block diagram showing components of an image field discrimination section used by the conventional copier shown in FIG. 1;

FIG. 3 is a block diagram showing components of an image forming apparatus according to a first embodiment of the invention;

FIG. 4 is a table showing final decisions that can be made by a final decision unit of the image forming apparatus shown in FIG. 3; and

FIG. 5 is a table showing final decisions that can be made by a final decision unit of an image forming apparatus according to a second embodiment of the invention.

### DETAILED DESCRIPTION OF THE PREFERRED EMBODIMENTS

An aspect of the present invention provides for utilizing both macro segmentation information and micro segmentation information in order to determine appropriate filtering and other types of processing to perform on various portions of image data obtained from a scanned document, prior to copying that document.

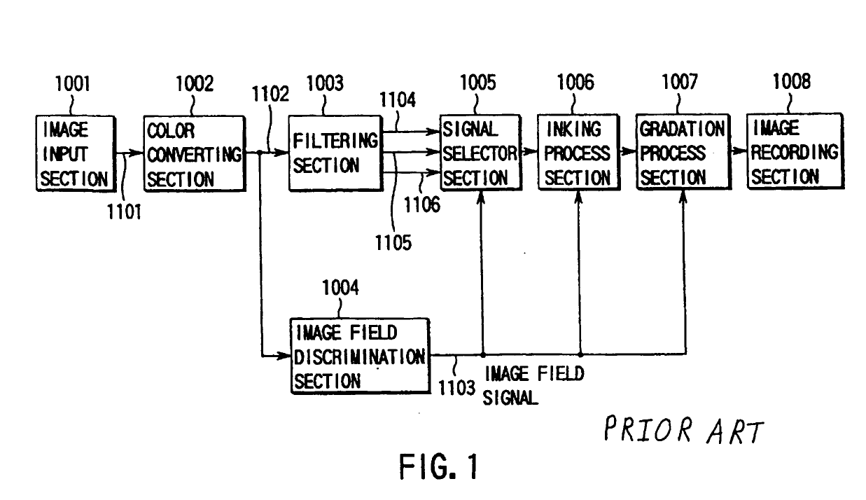

Before describing the present invention, a description will be made of micro segmentation processing and macro segmentation processing utilized in conventional copiers. FIG. 1 shows components of a conventional color copying machine in block diagram form. The color copying machine includes an image input section 1001, a color converting section 1002, an image field discriminating section 1004, a filtering section 1003, a signal selector section 1005, an inking process section 1006, a gradation processing section 1007 and an image recording section 1008.

The image input section 1001 reads an image of an original document so as to produce an output of a color image signal 1101. The color image signal indicates, for example, each reflectance of Red (R), Green (G) and Blue (B) of each pixel of the original document, whereby the output of the color image signal 1101 is produced in the form of three time-sequential signals obtained by two-dimensionally scanning information of each pixel. The number of read pixels per unit length is referred to as the pixel density.

The color converting section 1002 converts the color image signal 1101 indicating the reflectance of RGB into a color image signal 1102 denoting the density of a coloring material (for example, yellow, magenta and cyan or YMC) to be recorded. The conversion from RGB data to YMC data is done by way of non-linear functions, and is a non-trivial, processing-intensive process. Typically, a 3D table lookup method is utilized to perform this data conversion.

The image field discrimination section 1004 discriminates the attribute of each pixel in the supplied (color) image signal 1102 to produce an output of an image field signal 1103. For example, as described in U.S. Pat. No. 6,424,742, the attribute of a pixel can be one of three types: “character”, “edge of gradation”, and “smooth gradation”, whereby the image field signal 1103 is a signal having any one of values of these three attribute types.

The filtering section 1003 subjects the YMC color image signals 1102 to different filtering processes including a sharpening process and a smoothing process.

The inking process section 1006 converts the filtered YMC color image signals into YMCK signals (K corresponds to Black). Although black can be expressed by superimposing coloring materials in YMC, a general color recording process is performed by using YMCK coloring materials including a black coloring material (K) because the black coloring material excels in high density as compared to stacking YMC coloring materials, and also because the black coloring material is a lower-cost approach as compared to stacking YMC coloring materials to achieve a black color.

The gradation process section 1007 performs modulating processing, whereby a laser beam (not shown) is turned on/off based on an output of the gradation process section 1007. The modulation may include a two-pixel modulation method and a one-pixel modulation method. In particular, when the image field signal 1103 indicates a character, the one-pixel modulation method is used, and when the image field signal 1103 indicates a gradation image or a smooth section, the two-pixel modulation method is used. As a result, an image of a gradation field can be expressed with smooth gradation and a multiplicity of gradation levels, and a sharp image of a character field can be recorded with a high resolution.

The image recording section 1008 performs the actual image recording of an image on a paper, in a manner known to those skilled in the art.

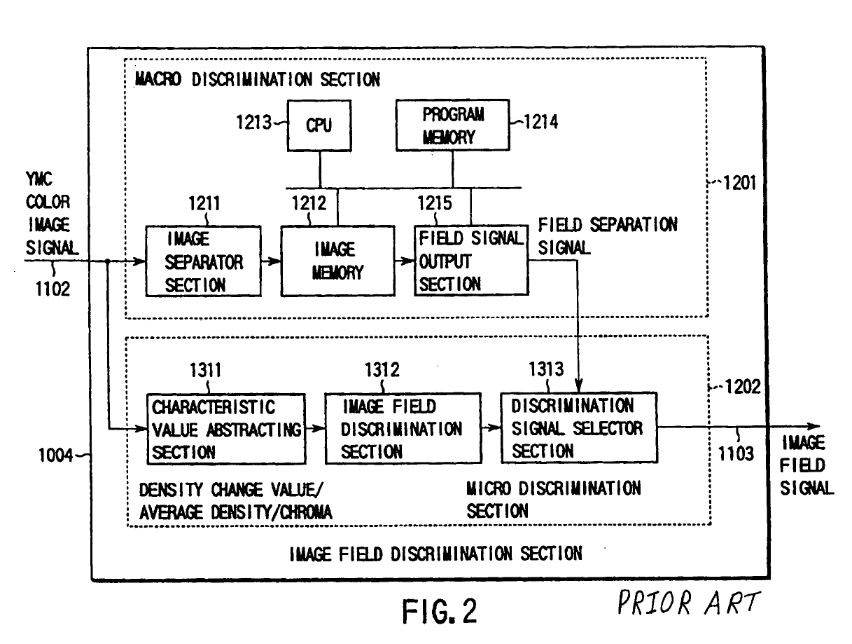

FIG. 2 shows details of the image field discrimination section 1004, including a macro discrimination section 1201 and a micro discrimination section 1202. The macro discrimination section 1201 includes an image separator section 1211, an image memory 1212, a CPU 1213, a program memory 1214, and a field signal output section 1215. The microdiscrimination section 1202 includes a characteristic value abstracting section 1311 for abstracting a plurality of (for example, three) characteristic values, an image field discrimination section 1312 for discriminating image fields of a plurality of types (e.g., five) types, and a discrimination signal selector section 1313.

The macro discrimination section 1201 performs field separation in accordance with the major structure of the image. For example, an image of an original document can be separated into the following five types of fields: a) Usual Character Field, b) Characters on Background, c) Continuous Gradation Field, d) Dot Gradation Field, and e) Other Field. These fields are further described in U.S. Pat. No. 6,424,742.

The image separator section 1211 separates the color image signal 1102 transmitted from the color converting section 1002 into image data in a plurality of planes in accordance with the difference in the density of peripheral pixels and a state of chroma. Separated image data is sequentially stored in the image memory 1212.

The image separator section 1211 may calculate brightness I and chroma S from the YMC color image signal 1102 in accordance with the following formulas: a) I=(C+M+Y)/3, b) S=(C−M)²+(M−y)²+(Y−C)².

In accordance with a program code stored in a program memory (e.g., a ROM) 1214, the CPU 1213 performs a field discrimination process while referring to the contents of separated image data stored in the image memory 1212 so that information about field separation is modified. The output of the macro discrimination section 1201 is a three-bit signal indicating the type of region as being either: 000=Usual Character Field, 001 (binary “1”) =Characters on Background, 010 (binary “2”)=Continuous Gradation Field, 011 (binary “3”)=Dot Gradation Field, or 100 (binary “4”)=Other Fields.

The micro discrimination section 1202 discriminates the field by paying attention to micro differences in the image, wherein a characteristic value abstracting section 1311 abstracts a plurality (e.g., three) of characteristic values, an image field discrimination section 1312 discriminates a plurality (e.g., five) types of image fields, and a discrimination signal selector section 1313 selects an image field based in part of information obtained from the field signal output section 1214 of the macro discrimination section 1201.

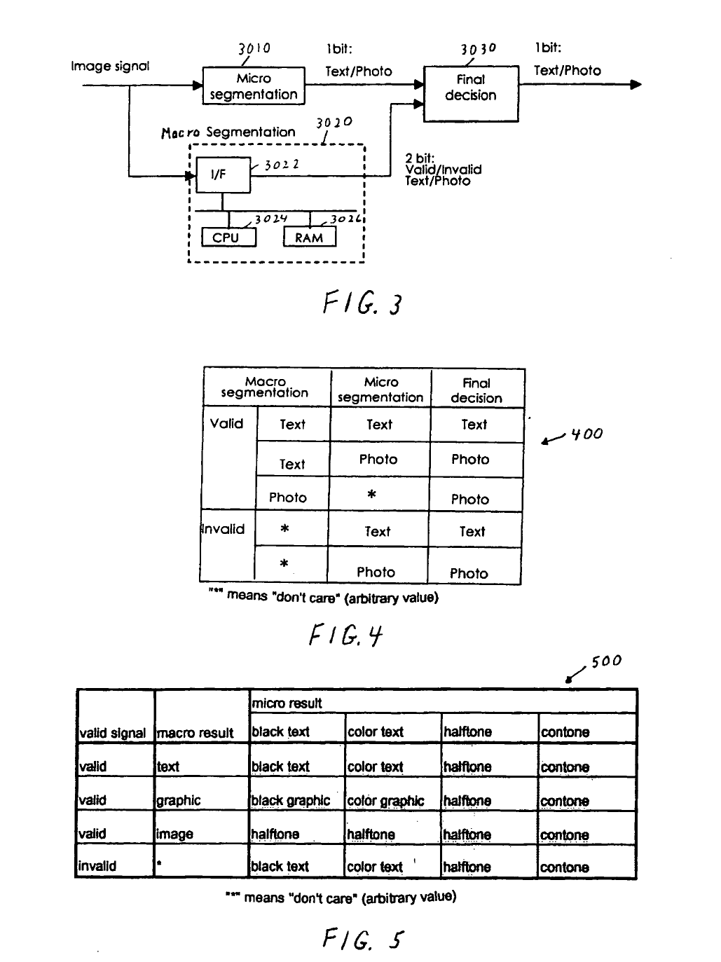

A first embodiment of the present invention will be described in detail with reference to FIG. 3. As mentioned earlier, the most appropriate type of processing to be performed on image data (e.g., scanned data of an document original scanned by a scanner) depends on the type of area being scanned. For example, text data should typically be processed using a filter that emphasizes edge enhancement properties, whereby the filter may be a low pass or band pass filter. For image data, on the other hand, low resolution and high gradation processing should typically be performed on the scanned data.

Thus, it is preferable to correctly divide a document original into text areas and non-text (e.g., image or graphics or photo) areas, so that each of those separate areas can be processed using appropriate techniques designed to enhance the printing of those different types of areas.

As explained above, micro segmentation processing determines differences in the microscopic structure of document image data. For example, in text areas, high frequency components are strong, but in photo areas, low frequency components are strong. Also, for example, image areas are typically made up of a plurality of dots, while text areas are typically made up of a plurality of solid lines. Thus, by distinguishing frequency components corresponding to dots/solid lines in a particular area of a document original, image areas can be distinguished from text areas in that same document.

In some cases, an image area may have a text-like component, such as at the edge of the image area. This can result in segmentation errors. Accordingly, an image forming device cannot make error-free determinations using only micro segmentation processing. That is why macro segmentation is also used in conjunction with micro segmentation.

There are two main macro segmentation processing techniques. In a first type, a large area of a document original is scanned and viewed, whereby a determination is made as to the type of the area based on whether the majority of pixels are text pixels or image pixels. In a second type, a layout analysis is performed based on a priori knowledge of document structures. For example, text is usually disposed on horizontal lines, and an image typically has some density value and is in a rectangular shape or a certain size on a page (e.g., greater than 1 cm×1 cm). Based on that information, determinations as to whether a particular area of a document image is a text area or an image area can be made on a macroscopic basis.

One problem with macro segmentation is that there is a need to view a fairly large area (e.g., a 100×100 pixel area in the first type described above, or nearly the entire page in the second type described above). This is compared to the relatively small areas (e.g., 10×10 pixel area) that have their respective types determined by the micro segmentation method.

Put in another way, the macro segmentation method makes determinations based on differences in the global structure of a document, and the processing rate changes according to the original and/or the complexity of the area being processed. The micro segmentation method makes determinations based on the microscopic structure of a document, and typically employs a fixed-rate processing method. Micro segmentation processing can do more processing in parallel with scanning output by a scanner because it only needs a small amount of data obtained from the document original to start performing its processing, whereby macro segmentation processing requires the scanner to output a much greater part (and possibly most if not all) of the document original in order to start performing its processing on the document. While for some images the variable speed of the macro segmentation is about the same or faster than micro segmentation processing, this is not always the case. Also, there may be instances whereby the use of both micro segmentation processing data and macro segmentation processing data causes inaccurate processing of scanned image data, because the macro segmentation processing has not completed processing of data in cases whereby a high speed printer requires printing in a time faster than the macro segmentation processing section can perform its function.

Accordingly, in a first embodiment of the invention, as seen in FIG. 3, image data (such as output from a not-shown scanner) is provided to both a micro segmentation unit 3010 and a macro segmentation unit 3020. The micro segmentation unit 3010 performs micro segmentation processing on the image data provided to it, in a manner known to those skilled in the art using any conventional micro segmentation processing unit or processor. For example, for each 10×10 pixel area, the micro segmentation unit 3010 determines whether that area is a text area or an image area, and it outputs a 1-bit signal for each pixel in that area based on its determination.

The macro segmentation unit 3020 performs macro segmentation processing on the image data provided to it, in a manner known to those skilled in the art using any conventional macro segmentation processing unit or processor. The micro and macro segmentation processing units may be part of the same controller or processor, such as through different circuits or programming. For example, for each 100×100 pixel area, the macro segmentation unit 3020 determines whether that area is a text area or an image area, and it outputs a 2-bit signal for each pixel in that area based on its determination, whereby one of the two bits in the 2-bit signal indicates the type of area. The macro segmentation unit 3020 includes an interface 3022, a central processing unit (CPU) 3024, and a random access memory (RAM) 3026. Though now shown in FIG. 3, the micro segmentation unit 3010 also includes similar components.

Now, based on a priori information regarding the speed of printing required for the printer, the macro segmentation unit 3020 provides a value for the other of the two bits in the 2-bit signal that indicates whether or not the type determination is valid or invalid.

By way of example and not by way of limitation, assume that the printer must print at a rate of 30 pages per minute, and that the micro segmentation unit 3010 performs its “type” determination for an entire page in the time allocated to it (e.g., 1 second) so as to meet the 30 pages per minute print requirement. Now, in a given circumstance the macro segmentation unit 3020 may only be able to properly process the top half of a page in the time allocated to it (e.g., within a 1 second time period). Also, assume that a macro area corresponds to ⅙ of a document page. Thus, in this example, the three macro areas making up the top half of a scanned document page were properly analyzed in time by the macro segmentation unit 3020, while the three macro areas making up the lower half of the scanned document page were not analyzed in time by the macro segmentation unit 3020.

Another alternative method to determine if the macro segmentation processing speed is valid or not is based on whether it is at least the same, or greater, than the micro segmentation processing speed. If yes, the macro segmentation result is valid, and if it is slower then the macro segmentation result is invalid.

Continuing with this example, the macro segmentation unit 3020 outputs a 2-bit signal for each of the pixels in the top three macro areas that indicates the “type” of pixel in the first bit position, and a “type determination” that corresponds to ‘valid’ in the second bit position (or vice versa). The 2-bit signal output for each of the pixels in the bottom three macro areas has a ‘don't care’ value (e.g., 0 or 1) for the type of pixel in the first bit position, and has a “type determination” that corresponds to ‘invalid’ in the second bit position.

The final decision unit 3030 receives the 1-bit data for each analyzed pixel of the scanned document from the micro segmentation unit 3010, and the 2-bit data for each analyzed pixel of the scanned document form the macro segmentation unit 3020, and outputs a final decision for each pixel based on that data. FIG. 4 shows a decision table that provides the possible logic determinations made by the final decision unit 3030. When the 2-bit data from the macro segmentation unit 3020 indicates that the corresponding pixel data is valid, then the final decision unit 3030 utilizes the information obtained from the macro segmentation unit 3020, along with the information obtained from the micro segmentation unit 3010 for that same pixel, in its decision making process. When the 2-bit data from the macro segmentation unit 3020 indicates that the corresponding pixel data is invalid, then the final decision unit 3030 utilizes only the information obtained from the micro segmentation unit 3010 for that same pixel in its decision making process.

Thus, according to the first embodiment, for portions of the scanned document that have been properly analyzed by both the macro segmentation unit 3020 and the micro segmentation unit 3010, a print determination is made based on the outputs from both units, while for other portions of the scanned document that have only been properly analyzed by the micro segmentation unit 3010, a print determination is made based solely on the output of the micro segmentation unit 3010. The utilization of an invalidity bit, or invalidity flag, provided by the macro segmentation unit 3020 (or other form of control unit monitoring the actions of the macro segmentation unit 3020) allows for more accurate final decisions to be made.

In FIG. 4, if the macro segmentation unit 3020 determines that a bit is a photo pixel, then the final decision unit 3030 determines that the bit is a photo pixel irrespective as to the decision made for that pixel by the micro segmentation unit 3010. If the macro segmentation unit 3020 determines that a bit is a text pixel, then the final decision unit 3030 determines the type of processing to be performed on that bit prior to sending it to a printer based on the output of the micro segmentation unit 3010. Also, if the macro segmentation unit 3020 outputs an invalid bit for a corresponding pixel, then the final decision unit 3030 determines the type of processing to be performed on that bit prior to sending it to a printer based solely on the output for that pixel by the micro segmentation unit 3010.

In the first embodiment, based on the validity signal output by the macro segmentation unit 3020 for each pixel when a portion of the document image is incapable of being processed in time by the macro segmentation unit 3020 (such as when a high speed print operation is utilized, or the image is complex), then a final segmentation result is decided based solely on the output of the micro segmentation unit 3010. Also, for the portions of the document image that have been processed in time by the macro segmentation unit 3020, then the final segmentation result is decided based on both the output of the micro segmentation unit 3010 and the output of the macro segmentation unit 3020. Accordingly, highly accurate segmentation can be achieved for all portions of a scanned document, using the best possible information available for each of those portions of the scanned document.

FIG. 5 shows a decision table 500 used by a final decision unit of a second embodiment of the invention, which has the same overall component structure as that shown in FIG. 3. In the second embodiment, the micro segmentation unit is capable of discriminating whether or not an area (e.g., a 10×10 pixel area) is a black text area, a color text area, a halftone image area, or a contone image area. The macro segmentation unit is capable of discriminating whether or not an area (e.g., a 100×100 pixel area) is a text area, a graphic area, or an image area. In the second embodiment, the micro segmentation unit outputs a two-bit signal for each pixel that it analyzes (e.g., each of the 100 pixels of the 10×10 pixel area are output having the same “type” of area based on the discrimination performed by the micro segmentation unit), whereby “00”, may correspond to “black text”, “01” to “color text”, “10” to “halftone”, and “11” to “contone”. The conversion of each analyzed pixel in either a macro area as analyzed by the macro segmentation unit, or a micro area as analyzed by the micro segmentation unit, at a pixel-by-pixel level, can be performed in hardware or in software using any of a variety of techniques known to those skilled in the art.

In more detail, to compare the processing speed of micro segmentation processing and macro segmentation processing, a unit of output of the micro segmentation processing is pixel-by-pixel (e.g., one pixel at a time), while a unit of output of the macro segmentation processing is greater, such as 10×10 pixels (e.g., 100 pixels at a time). The unit of output of the macro segmentation processing is then converted to a pixel-by-pixel unit output in hardware, for example, so that the total processing time for micro segmentation processing and for macro segmentation processing can be compared at a pixel by pixel level. The comparison of processing speeds in this manner also may apply to the first embodiment described previously.

Thus, if the total time for performing pixel-by-pixel output of the macro segmentation processing is greater than the total time for performing pixel-by-pixel output of the micro segmentation processing, in one embodiment, this results in the outputs of the macro segmentation processing to be deemed invalid. In another embodiment, if the total time for the pixel-by-pixel output of the macro segmentation processing is less than the required print speed, then the output of the macro segmentation processing is valid, otherwise it is invalid.

The macro segmentation unit of the second embodiment outputs a three-bit signal for each pixel that it analyzes, whereby “000” may correspond to “valid bit that is a text pixel”, “001” to “valid bit that is a graphic pixel”, “010” to “valid bit that is an image pixel”, and “100” to “invalid bit”. In this example, the first bit of the three-bit signal is the valid/invalid bit, and thus “100”, “101”, “110”, and “111” output by the macro segmentation unit all correspond to an invalid pixel. Then, the type of pixel corresponding to that pixel location is determined based solely on the information for that pixel output by the micro segmentation unit. The “text” type in this example corresponds to “character or string”, the “graphic” type corresponds to “graphic, figure (combination of line, circle, etc.), the “image” type corresponds to “something like a photo”, the “halftone” type corresponds to “image on printed image”, and the “contone” type corresponds to “image on continuous tone (such as photography) ”.

For each of the first and second embodiments, the number of bits output by the micro segmentation unit and the macro segmentation unit are based on the number of types of areas (and thus pixels) that can be discriminated by these units. Further, the macro segmentation unit provides an additional output bit for the validity indication for each output pixel value. Thus, for a micro segmentation unit that can make a 7-type discrimination on a micro area, a three-bit signal is output for each pixel of a scanned original. For a macro segmentation unit that can make a 5-type discrimination on a macro area, a four-bit signal is output for each pixel of a scanned original, since three bits are required for a “type” of pixel indication and one bit is required for a “valid/invalid” indication.

Also, the macro segmentation unit is preferably inputted with a required processing speed for each print operation, whereby that required processing speed is converted to a required processing time so that pixels that are processed within that time are output with a “valid” indication and pixels that are not processed within that time are output with an “invalid” indication (and perhaps with “don't care” bits for the “type” of pixel).

In a third embodiment, the validity determination is performed by a validity determination unit separate from the macro segmentation unit, whereby, based on a priori knowledge of the sequence in which the macro segmentation unit performs its “type” analysis, e.g., starting from the top left of a page in units of 200×200 pixel macro blocks, and based on information concerning the required print speed for the printer (or based on the relative processing speed of the micro segmentation processing on a pixel-by-pixel basis as compared to macro segmentation processing on a pixel-by-pixel basis for an alternative embodiment), a validity signal is output by the validity determination unit for each pixel, based solely on that data. Thus, as one example, if a 50 page per minute print speed is required, the validity determination unit determines, based on a priori knowledge of how fast its takes the macro segmentation unit to process each 100×100 pixel area in a scanned document, that only the pixels in the first two macro blocks (20,000 pixels) of a 100,000 pixel document are valid, while the other (80,000 pixels) of the 100,000 pixel document are invalid. This validity information is provided to the final decision unit separate from the macro type determination data provided to the final decision unit by the macro segmentation unit, whereby the final decision unit combines this data, along with the information provided by the micro segmentation unit, to make a pixel-by-pixel segmentation decision that is used to determine an appropriate image processing to be performed on that image data prior to printing an image based on the image data. Such a validity determination may be associated, and be part of, a controller or processor in the printer.

In a fourth embodiment of the invention, the final decision unit utilizes only the macro segmentation processing output when the macro segmentation processing output is valid (as determined by the validity flag provided for each pixel data output by the macro segmentation processing unit), and the final decision unit utilizes only the micro segmentation processing output when the macro segmentation processing output is invalid. The fourth embodiment provides for a simpler and faster final decision unit as compared to the other described embodiments, whereby the output of the final decision unit may not be as accurate as the other described embodiments.

The foregoing description of a preferred embodiments of the invention has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method of copying a document, comprising:
scanning a document and obtaining an image signal from the scanned document;
performing micro segmentation processing on the image signal, and outputting, for at least one pixel, first data indicative of a type of the pixel;
performing macro segmentation processing on the image signal, and outputting, for the at least one pixel, second data indicative of a type of the pixel and a validity flag that indicates whether the second data is valid; and
determining a pixel type based on the validity flag and at least one of the first data and the second data.

2. The method according to claim 1, wherein the micro segmentation processing is performed for all pixels in a first area of the scanned document to obtain a same micro segmentation processing result for each of the pixels in the first area,
wherein macro segmentation processing is performed for all pixels in a second area of the scanned document to obtain a same macro segmentation result for each of the pixels in the second area, and
wherein the second area is greater than the first area.

3. The method according to claim 1, further comprising:
copying a document based on the pixel type determination.

4. The method according to claim 1, wherein the first data includes data indicating whether a pixel is a text pixel or a non-text pixel.

5. The method according to claim 4, wherein the non-text pixel is one of a photo pixel and a graphics pixel and an image pixel.

6. The method according to claim 1, further comprising:
determining a copying speed for copying the document,
wherein the validity flag is output for each pixel based on processing time of the macro segmentation processing as compared to a copying time corresponding to the copying speed.

7. The method according to claim 2, further comprising:
determining a macro segmentation processing speed for performing macro segmentation processing of the scanned document on a pixel-by-pixel level,
wherein, if the macro segmentation processing speed is greater than a micro segmentation processing speed for performing micro segmentation processing of the scanned document on a pixel-by-pixel level, then each second data output has an invalid indication in the validity flag that is associated therewith.

8. The method according to claim 2, wherein, for each pixel having a corresponding validity flag indicating invalid, the pixel type in the determining step is based solely on the first data for that pixel.

9. The method according to claim 2, wherein, for each pixel having a corresponding validity flag indicating valid, the pixel type in the determining step is based on both the first data and the second data.

10. An image forming apparatus, comprising:
a scanning unit configured to scan a document and to obtain an image signal from the scanned document;
a micro segmentation processing unit configured to perform micro segmentation processing on the image signal, and to output, for at least one pixel, first-data indicative of a type of the pixel;
a macro segmentation processing unit configured to perform macro segmentation processing on the image signal, and to output, for the at least one pixel, second data indicative of a type of the pixel and a validity flag that indicates whether the second data is valid; and
a final decision unit configured to determine a pixel type based on the validity flag and at least one of the first data and the second data.

11. The image forming apparatus according to claim 10, wherein the micro segmentation processing is performed for all pixels in a first area of the scanned document to obtain a same micro segmentation processing result for each of the pixels in the first area,
wherein macro segmentation processing is performed for all pixels in a second area of the scanned document to obtain a same macro segmentation result for each of the pixels in the second area, and
wherein the second area is greater than the first area.

12. The image forming apparatus according to claim 10, further comprising:
a copying unit configured to copy a document based on the pixel type determination.

13. The image forming apparatus according to claim 10, wherein the first data includes data indicating whether a pixel is a text pixel or a non-text pixel.

14. The image forming apparatus according to claim 13, wherein the non-text pixel is one of a photo pixel and a graphics pixel and an image pixel.

15. The image forming apparatus according to claim 10, further comprising:
a copying speed determining unit configured to determine a copying speed for copying the document,
wherein the validity flag is output for each pixel based on processing time of the macro segmentation processing as compared to a copying time corresponding to the copying speed.

16. The image forming apparatus according to claim 11, further comprising:
a determining unit configured to determine a macro segmentation processing speed for performing macro segmentation processing of the scanned document on a pixel-by-pixel level,
wherein, if the macro segmentation processing speed is greater than a micro segmentation processing speed for performing micro segmentation processing of the scanned document on a pixel-by-pixel level, then each second data output has an invalid indication in the validity flag that is associated therewith.

17. The image forming apparatus according to claim 1 1, wherein, for each pixel having a corresponding validity flag indicating invalid, the pixel type as made by the final decision unit is based solely on the first data for that pixel.

18. The image forming apparatus according to claim 1 1, wherein, for each pixel having a corresponding validity flag indicating valid, the pixel type as made by the final decision unit is based on both the first data and the second data.

19. The image forming apparatus according to claim 11, wherein, when the second data output from the macro segmentation processing unit corresponds to “text” for a particular pixel, the final decision unit determines a type of the particular pixel in accordance with a type of the particular pixel as output by the micro segmentation processing unit.

20. An image forming apparatus, comprising:
a scanning unit configured to scan a document and to obtain an image signal from the scanned document;
a micro segmentation processing unit configured to perform micro segmentation processing on the image signal, and to output, for at least one pixel, first data indicative of a type of the pixel;
a macro segmentation processing unit configured to perform macro segmentation processing on the image signal, and to output, for the at least one pixel, second data indicative of a type of the pixel;
a validity flag setting unit that sets a validity flag for each pixel output from the macro segmentation processing unit based on at least a pixel level processing speed of the macro segmentation processing unit; and
a final decision unit configured to determine a pixel type based on the validity flag and at least one of the first data and the second data.

21. A program product for printing a document, the program product comprising machine-readable program code for causing, when executed, one or more machines to perform the following method steps comprising:
scanning a document and obtaining an image signal from the scanned document;
performing micro segmentation processing on the image signal, and outputting, for at least one pixel, first data indicative of a type of the pixel;
performing macro segmentation processing on the image signal, and outputting, for the at least one pixel, second data indicative of a type of the pixel and a validity flag that indicates whether the second data is valid; and
determining a pixel type based on the validity flag and at least one of the first data and the second data.

22. The program product according to claim 21, wherein the micro segmentation processing is performed for all pixels in a first area of the scanned document to obtain a same micro segmentation processing result for each of the pixels in the first area,
wherein macro segmentation processing is performed for all pixels in a second area of the scanned document to obtain a same macro segmentation result for each of the pixels in the second area, and
wherein the second area is greater than the first area.

23. A method of copying a document, comprising:
scanning a document and obtaining an image signal from the scanned document;
performing micro segmentation processing on the image signal, and outputting, for at least one pixel, first data indicative of a type of the pixel;
performing macro segmentation processing on the image signal, and outputting, for the at least one pixel, second data indicative of a type of the pixel and a validity flag that indicates whether the second data is valid;
determining a pixel type of a pixel to be copied from the second data when the validity flag of the corresponding pixel to be copied is valid, and determining the pixel type of the pixel to be copied from the first data when the validity flag of the corresponding pixel to be copied is invalid.

24. An image forming apparatus, comprising:
a scanning unit configured to scan a document and to obtain an image signal from the scanned document;
a micro segmentation processing unit configured to perform micro segmentation processing on the image signal, and to output, for at least one pixel, first data indicative of a type of the pixel;
a macro segmentation processing unit configured to perform macro segmentation processing on the image signal, and to output, for the at least one pixel, second data indicative of a type of the pixel and a validity flag that indicates whether the second data is valid;
a determining unit configured to determine a pixel type of a pixel to be copied from the second data when the validity flag of the corresponding pixel to be copied is valid, and to determine the pixel type of the pixel to be copied from the first data when the validity flag of the corresponding pixel to be copied is invalid.
